(19) United States
(12) Patent Application Publication
(10) Pub. No.: US 2005/0114847 A1
(43) Pub. Date: May 26, 2005

(54) Method, apparatus and computer program for automatically determining compile-time module dependencies

(75) Inventor: Ian Nicholas Whalley, Pawling, NY (US)

Correspondence Address: HARRINGTON & SMITH, LLP, 4 RESEARCH DRIVE, SHELTON, CT, 06484-6212, US

(73) Assignee: International Business Machines Corporation

(21) Appl. No.: 10/723,109

(22) Filed: Nov. 25, 2003

(51) Int. Cl. G06F 9/45

(52) U.S. Cl. 717/140

(57) ABSTRACT

Disclosed is a method, a system and a computer program that is stored on a computer-readable medium and that contains computer program instructions. The computer program instructions direct a computer to monitor the operation of at least one data transformation tool and to automatically record information, from data set manipulation behavior of the at least one data transformation tool, that is descriptive of dependencies inherent in data sets being manipulated. The recorded information is used during subsequent operation of the data transformation tool so as to avoid manipulating a particular data set that the recorded information indicates, in conjunction with other information, would not have changed since it was created or last modified. The other information may comprise at least data and time information that reflects when that the data set was created or last modified. The data transformation tool can include a software project building tool, the data sets being manipulated can be files, and the computer program instructions that direct the computer to monitor the manipulation behavior can monitor a file system.

### TECHNICAL FIELD

These teachings relate generally to data processing systems and to software development tools and, more specifically, relate to software building tools that are responsive to dependencies to provide an incremental build capability.

### BACKGROUND

A significant amount of the work that computers perform can be categorized as ‘data transformation’. That is to say, computer software takes data as input, transforms it in some way, and emits data as output. Much of this work is extremely repetitive in at least two ways. Firstly, there is a considerable amount of data to transform; and secondly, much of the same data is transformed over and over again. In this second instance, much of the data does not in fact need to be transformed again as the input data may not have been changed since the transformation was last performed.

The process of ‘building’ software (commonly referred to as ‘compilation’) has been employed for almost as long as software has existed. Until recently the software building process was generally as simple as taking the human-readable (‘source code’) form of the software and transforming it into the computer-executable (‘object code’) form of the software. However, as time has progressed the software has tended to become more complicated and, with this increase in complexity, a corresponding increase in the complexity of the build process has occurred.

Building software is no longer as simple as taking source files in C or C++ (or some other such language), compiling each source file into one (and only one) ‘object’ file, and then linking various combinations of these object files into executable components and libraries. In the modem development project, building software involves multiple transformation stages, each of which results in various numbers of output files.

Another aspect of the building stage of software development has, for many years, been demonstrated by the software tool ‘make’. One ‘make’ reference book is “Managing Projects with make” (2nd ed.), by Andy Oram & Steve Talbott, O'Reilly and Associates, 1991. An additional ‘make’ reference, for a modem enhanced variant of ‘make’ referred to as ‘GNU make’, is <http://www.gnu.org/software/make/manual/html_chapter/make_toc.html>, from the GNU Project. In more recent years, other such tools (including, but not limited to, ‘ant’) have been developed to improve upon ‘make’ (‘ant’ is specifically intended (originally) for projects utilizing the JAVA™ language (JAVA is a trademark of Sun Microsystems, Inc.)) One ‘ant’ reference book is ‘Ant: The definitive guide’, by Jesse E. Tilly & Eric M. Burke, O'Reilly and Associates, 2002. The official ‘ant’ manual is <http://ant.apache.org/manual/>. These types of tools are referred to herein as a ‘project building tool’. The purposes of project building tools are many-fold. Most notably, they permit the automation of complex build processes, and they permit so-called ‘incremental builds’ to be performed. ‘Incremental builds’ are builds wherein only those parts (typically files) of the source code that have changed are re-built. In this way, developers of software projects can build their project quickly after small changes, because they are not required to re-compile every part of the project every time that a change is made to one part.

In order to provide this incremental building functionality, it is very useful if the project building tool is able to determine so-called ‘dependencies’, i.e., is enabled to determine which input file(s) produce which output file(s). For example, in a simple case of a two stage build process an input file ‘foo.c’ produces the output file ‘foo.o’ when run through the tool ‘gcc’. When ‘foo.o’ is used as the input file to the tool ‘1d’, it produces ‘foo’ as the output file. The project building tool can use this information when it is run. For example, in the case of ‘make’ it checks for the existence, and the last-modified-date of, the input file(s) and the output file(s). In the example given, if ‘foo.o’ (the output file from the first stage) exists and is dated more recently than ‘foo.c’ (the input file to the first stage), the first stage (executing ‘gcc’) can be skipped. Similar testing can be performed for the second stage.

In a more complex example, the first stage input files are ‘foo.c’, ‘bar.c’ and ‘frobnitz.c’, and ‘gcc’ is run once per input file to produce, respectively, ‘foo.o’, ‘bar.o’, ‘frobnitz.o’. ‘id’, the second stage tool, is then run once, with three input files (‘foo.o’, ‘bar.o’, ‘frobnitz.o’) to produce a single output file, ‘foo’. In this case, before running ‘1d’ in second stage, (assuming that all three input files, and the output file, exist) the project building tool will only need to run ‘1d’ (the second stage tool) if the date on at least one of three input files is more recent than the date on the output file (‘foo’).

Originally, with ‘make’, these dependencies were either (a) deduced by the project building tool (the tool is safe to assume, for example, that ‘foo.c’ compiles to (only) ‘foo.o’); or (b) were added manually by the project developer (the developer must tell the tool, for example, that ‘foo’ comes from ‘foo.o’, ‘bar.o’, and ‘frobnitz.o’). Later, tools to deduce dependencies were produced that both helped generalize (a), and remove the burden from the developer of (b). Instead of having to enter the dependencies manually, the developer need simply run the dependency generation tool (or have the project building tool run it). The advent of these dependency checking tools was a boon to developers, most of whom have experienced the confusion that results from an out-of-date set of dependencies preventing reliable incremental building.

However, these dependency generation tools are required to understand the programming language in use. For example, it is customary for them to ‘preprocess’ the input files, and deduce from contents of the input files what the output file(s) will be. Consequently, new dependency generation tools are continually required for new languages, new formats, and new systems.

However, modem software development continues to increase in complexity. For example, one current development model involves the following series of transformations:
(a) one .GWSDL file->multiple .WSDL files (via the tool ‘GWSDLtoWSDL’);
(b) one of the .WSDL files->multiple JAVA files (via the tool ‘WSDLtoJava’);
(c) multiple .JAVA files->multiple (not one to one).CLASS files (via the tool ‘javac’);
(d) multiple CLASS files->multiple JAR files (via the tool ‘jar’); and
(e) multiple JAR files->a WAR file (via the tool ‘war’).

Of these five stages (a)-(e), the execution of the first three do not result in anything that is directly deliverable to a customer or end user. They instead result in intermediate outputs, that is, in files or objects that are used as inputs to subsequent stages. However, the precise output files from each of these stages are difficult to deduce by inspecting the input files. Further, the tools used in each stage do not provide features to list the output files, and other tools to perform this function are not available.

As may be appreciated, the foregoing situation makes accurate dependency checking for the purpose of performing incremental builds practically impossible. In fact, the only reliable way to determine precisely which output files come from each input file, or set of input files, is to run the tool in question and see what is created. This makes it difficult, if not impossible, to perform incremental builds, as it has been shown that good dependency analysis is important for achieving accurate and reliable incremental builds.

Several techniques have arisen to avoid these problems. One technique that should be most familiar to those skilled in the art can be illustrated by the .GWSDL->multiple .WSDL files stage (a). In this scenario, the developer runs the transformation tool (which is, in this case, referred to as GWSDL_to_WSDSL) manually on the .GWSDL file, and observes the files produced. The developer then selects one or more of the .WSDL files (by whatever means), and declares the selected file(s) to be the one(s) that are to be used for the dependency checking of this stage. The project building tool is then able to compare the date on the .GWSDL file with that on the selected .WSDL file(s), and hence determine whether or not to the .GWSDL file needs to be processed.

However, this essentially manual process has several drawbacks. For example, the developer may select the .WSDL file(s) poorly, the tool may not always produce all the .WSDL files (for example, it might determine that whilst the .GWSDL has changed, only some of the resultant .WSDL files need to be regenerated, and only regenerate those), the tool itself may change to produce different files, thereby invalidating the manually-chosen dependencies. In addition, manually selecting dependencies is excessively time consuming, and the selections must be periodically re-checked to ensure that they are still appropriate.

### SUMMARY OF THE PREFERRED EMBODIMENTS

The foregoing and other problems are overcome, and other advantages are realized, in accordance with the presently preferred embodiments of these teachings.

Disclosed is a method, a system and a computer program that is stored on a computer-readable medium and that contains computer program instructions. The computer program instructions direct a computer to monitor the operation of at least one data transformation tool and to automatically record information, from data set manipulation behavior of the at least one data transformation tool, that is descriptive of dependencies inherent in data sets being manipulated. The recorded information may be used during subsequent operation of the data transformation tool so as to avoid manipulating a particular data set that the recorded information indicates, in conjunction with other information, would not have changed since it was created or last modified. The other information may comprise at least data and time information that reflects when the data set was created or last modified. In a presently preferred, although non-limiting embodiment of this invention the data transformation tool includes a software project building tool, the data sets being manipulated comprise files, and the computer program instructions that direct the computer to monitor the manipulation behavior monitor a file system.

### BRIEF DESCRIPTION OF THE DRAWINGS

The foregoing and other aspects of these teachings are made more evident in the following Detailed Description of the Preferred Embodiments, when read in conjunction with the attached Drawing Figures, wherein:

FIG. 1 is logic flow diagram that shows a process in accordance with this invention;

FIG. 2 is a simplified block diagram of a data processing system that is constructed and operated in accordance with this invention to have a file system monitoring tool interposed between a project building tool and a data storage system that holds a file system; and

FIG. 3 is an example of a completed dependency table that is constructed by the file system monitoring tool in response to the operation of the project building tool.

### DETAILED DESCRIPTION OF THE PREFERRED EMBODIMENTS

It was discussed above that a technique to determine dependencies is to manually execute the data transformation tools and observe which output data is created. In the case of project building tools, for example, this can be achieved by observing which output files are created by executing the various sub-tools.

This invention automatically monitors various data transformation tools and automatically determines, from their behaviors, the dependencies inherent in the data sets being manipulated. Using the example of the project building tool, the invention employs file-system monitoring techniques (such as file monitoring techniques employed in the field of anti-virus software) to observe the reading from files, the modification of files and the creation of files. By integrating a project building tool with an appropriate file system monitoring subsystem, this invention in one aspect thereof enables accurate dependency checks to be performed even on modem, complex, software projects.

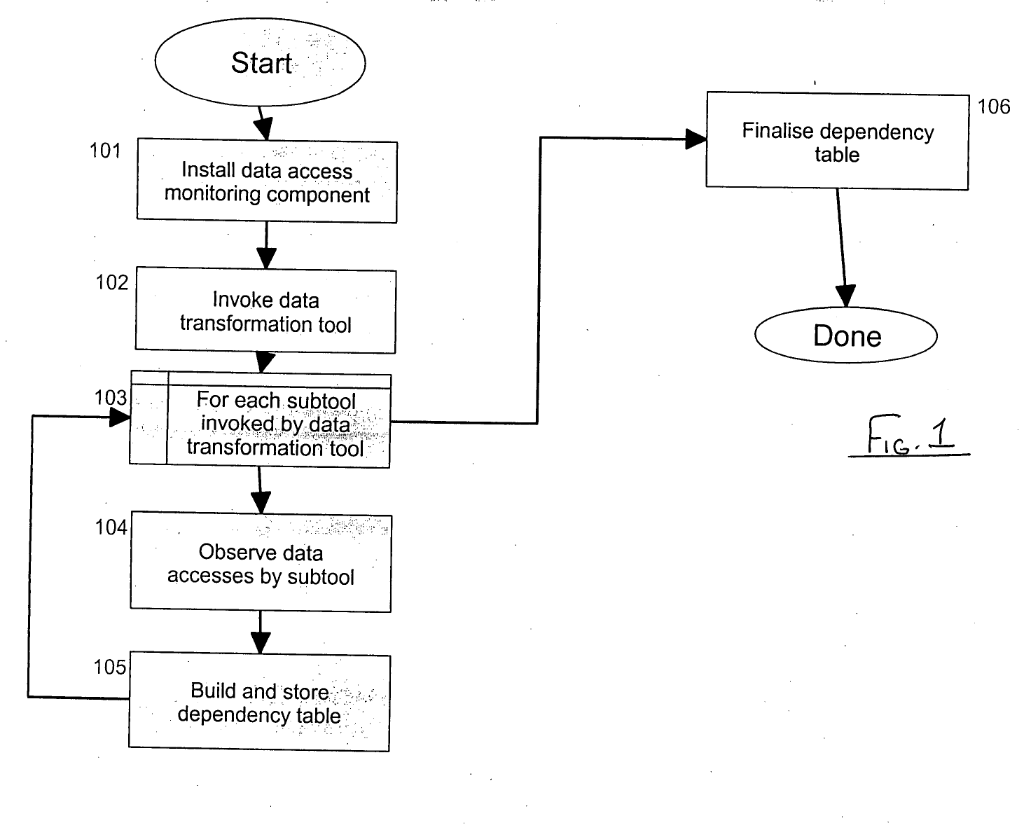

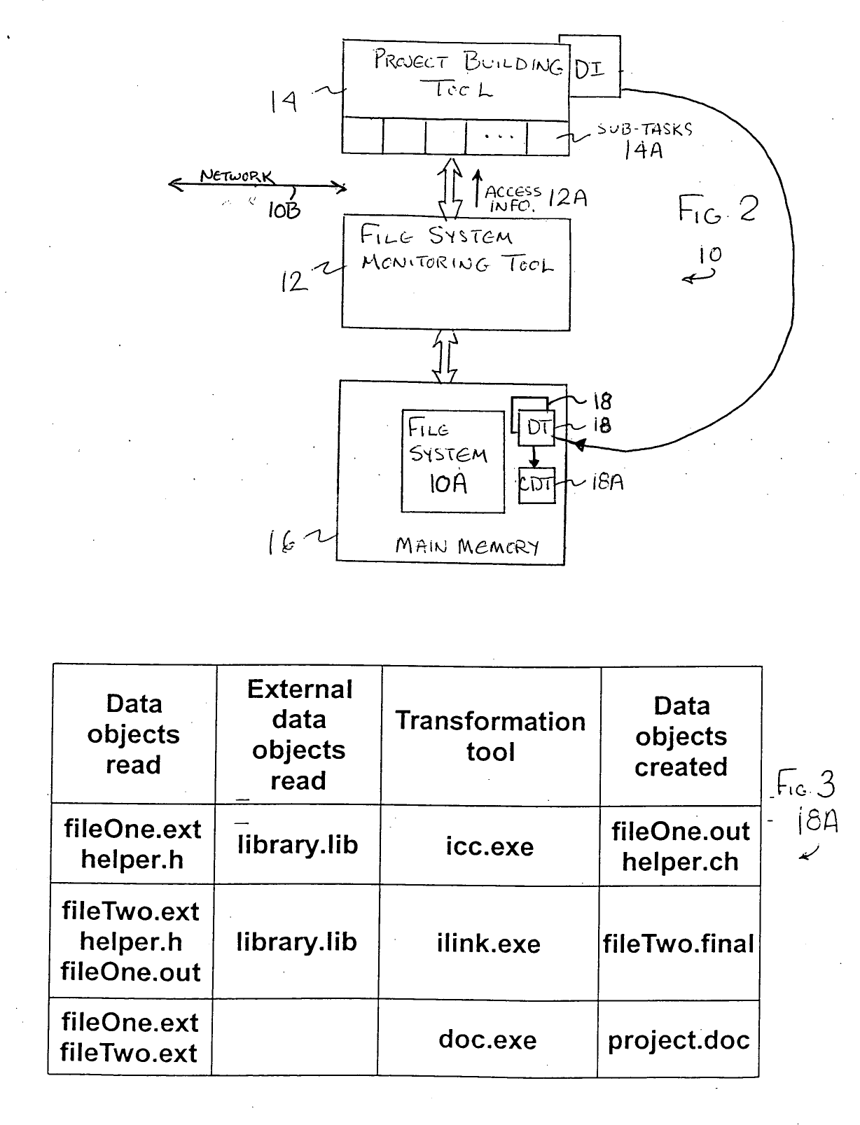

FIG. 1 illustrates the control flow within an embodiment of the invention, and FIG. 2 illustrates a simplified block diagram of a data processing system 10 that is constructed and operated in accordance with the invention. At Block 101 a data access monitoring component (as in the embodiment described above, a file system monitoring subsystem 12) is installed in such a way as to receive information about files accessed, and tools run by, a data transformation tool (in the embodiment described above, the project building tool 14). For example, the file system monitoring subsystem 12 can be installed between the project building tool 14 and a main memory 16 where is stored a file system 10A, and can thus monitor file system 10A related activities (e.g., file creation, deletion, modification and reading events). The main memory 16 may be a semiconductor memory and/or a disk memory, and may be resident in the system 10 or remotely located therefrom, and reachable through a network connection. The data transformation tool (in the embodiment described above, the project building tool 14) is executed at Block 102 of FIG. 1. The tool 14 then exhibits its standard behavior, which involves executing the various sub-tools or sub-tasks 14A that are involved in the overall data transformation task (Block 103). These executions are observed at Block 104 by the monitoring component (e.g., by the file system monitoring subsystem 12), which in turn builds and stores at Block 105 a dependency table (DT) 18 for that particular execution of that particular sub-task 14A. The result is a plurality of the dependency tables 18 (e.g., one for each sub-task 14A) that may be stored in the memory 16 of FIG. 2. After the sub-tasks 14A have been executed (possibly as the data transformation tool 14 exits, or possibly sometime after it has exited), a final combined dependency table (CDT) 18A is constructed (Block 106) from the individual dependency tables 18.

Note that the data processing system 10 may represent a stand-alone, localized computer system, or it could represent a distributed computer system wherein at least some of the functional connections between the major blocks are made through one or more data communication paths and/or networks. It may also be possible for a user to interact with the data processing system 10, such as with the file system monitoring tool 12 and/or the project building tool 14, either locally or over a data communications network 10B. As but one example, the user may be able to remotely receive reports that summarize the operation of the project building tool 14, and may possibly also be permitted to obtain access to the information stored, in accordance with an aspect of this invention, in the dependency table(s) 18, 18A. Other network-implemented user services are also within the scope of this invention.

FIG. 3 illustrates an example of the final dependency table 18A for a variation of the project building embodiment discussed above. In this embodiment, the project in question is considered to have two end-products: ‘fileTwo.final’ and ‘project.doc’; and three input files: ‘fileOne.ext’, ‘fileTwo.ext’, and ‘helper.h’. When the project was built, the monitoring subsystem (the file system monitoring subsystem 12 in this embodiment) observed (and recorded) the following events.

Firstly, the tool ‘icc.exe’ was executed. The tool ‘icc.exe’ read ‘fileOne.ext’ and ‘helper.h’ from the project, and read ‘library.lib’ from elsewhere on the system 10 (considered to be an “external data object”, as shown in FIG. 3). The tool ‘icc.exe’ then constructed ‘fileOne.out’ and ‘helper.ch’.

Secondly, the tool ‘ilink.exe’ was executed. It read ‘fileTwo.ext’, ‘ihelper.h’, and ‘fileOne.out’ from the project, and ‘library.lib’ from elsewhere on the system 10. It then constructed ‘fileTwo.final’.

Thirdly, the tool ‘doc.exe’ was executed. The tool ‘doc.exe’ read ‘fileOne.ext’ and ‘fileTwo.ext’ from the project, and constructed ‘project.doc’.

In one preferred embodiment the project building tool 14 is initially (and periodically) executed in a mode that ensures a complete build. That is, the project building tool 14 is executed in a non-incremental build fashion such that every input file is processed, regardless of previously understood dependency information. This can be accomplished in several ways apparent to those skilled in the art, including, but not limited to, deleting all previously generated files manually, or extracting an unmodified version of the source code into an empty storage location from whatever means is used to store those files (usually a source-code control system of some kind). As the complete build is performed, the project building tool 14 interacts with the file-system monitoring subsystem 12 which informs the project building tool 14 as files are read, modified, created, and deleted on the file system 10A of the system 10. Those skilled in the art will understand that it will often be necessary to limit precisely what the monitoring subsystem 12 monitors. This can be accomplished either by limiting the storage areas monitored to only those used by the project building system 14, or by only monitoring file system 10A accesses from the project building system 14, and sub-tasks 14A started by the project building tool 14.

As the project building tool 14 executes each stage of the (complete) build in turn, it receives communications (access information 12A) from the file system monitoring subsystem 12. The project building tool 14 stores the received access information 12A such that it is logically connected to the stage of the build that produced the reported accesses. For example, the project building tool 14 knows that when it executes the GWSDL_to_WSDL tool on foo_port_type.gwsdl, the file system monitoring subsystem 12 reported:
foo_port_type.gwsdl was read;
foo_port_type.wsdl was created;
foo_service.wsdl was created;
foo_bindings.wsdl was created.

Similarly, the project building tool 14 knows that when it executes the WSDL_to_JAVA tool on foo_service.wsdl, the file system monitoring subsystem 12 reported:
foo_service.wsdl was read;
foo_bindings.wsdl was read;
foo_port_type.wsdl was read;
foo_service.java was created;
types.java was created.

The project building tool 14 stores the access information 12A as the build progresses and constructs the DT 18 from observed dependency information. It can be seen that the dependency information can be derived at least in part from the access information 12A that is received from the file system monitoring subsystem 12, which in turn is based on the combined dependency table 18A. Thereafter, when the project building tool 14 is executed, it is able to use this dependency information in the DT 18 in order to determine whether or not each build step needs to be executed based on the recorded date and time information of the various input and output files identified by the dependency information.

In general, an existing dependency information database, also referred to above as the CDT 18A, (if it exists) is read, and is used by the project building tool 14 to decide what needs to be built and what does not. This database may require updating based upon this execution of the project building tool 14, and the updating can be performed during the operation of the project building tool 14, or in a batch as the operation finalizes. The first time the project building tool 14 is executed, it is likely that there will not be an existing dependency information database, and so the build process starts without any information, performs all of the build steps specified, and constructs the dependency information database in the form of the CDT 18A, in the same manner as when it is updating the

Based on the foregoing it can be appreciated that this invention provides a technique for maintaining consistency of data or a program. The technique includes inserting the monitoring tool 12 between the application (the project building tool 14 in the example given above) and a data storage facility, such as the main memory 16. The monitor 12 observes actions that take place in the data storage facility and recognizes when those actions have the potential for changing certain dependencies and, in response, performs some action, such as a data manipulation step or steps, in response to the actions. In the preferred embodiment the data storage facility includes the file system 10A. When the program is the project build tool 14 the data are preferably the inputs, intermediate outputs, and outputs of the project build process. The data manipulation steps may include the performance of maintenance steps.

Furthermore, the monitoring tool 12 can be used each time the build tool 14 is exercised, and the dependency information 18A can be updated every time that the build tool 14 is exercised. It is also within the scope of this invention to generate the dependency information 18A on the fly, during operation of the monitoring tool 12, and each time that the build tool 14 is exercised. Also, it is within the scope of this invention to use Terminate and Stay Resident/File System Filter Driver (TSD/FSFD) file system 10A monitoring, or to use LD_LIBRARY_PRELOAD style file system 10 monitoring.

More specifically, there are at least two technical ways in which the project building tool 14 can perform the monitoring function. The two techniques mentioned above, i.e., TSD/FSFD file system monitoring and LD_LIBRARY_PRELOAD file system monitoring, are conventional approaches to what is commonly referred to as “hooking file accesses”, i.e., placing a piece of software into the system such that it either (a) receives notification of file accesses (including open, write, read, close, seek, etc); or (b) receives notification of those accesses and is able to control whether or not those accesses are permitted to succeed. Option (b) is frequently used in anti-virus software, where the anti-virus software hooks file accesses such that before a file is opened, the anti-virus software can check the file for viruses. If viruses are found, the anti-virus software prevents the file open from succeeding, otherwise it will permit the open to succeed. Option (a) is the preferred technique for use by this invention, as this invention does not require the hook to modify or prevent file access calls from succeeding.

TSR (Terminate and Stay Resident) refers to a specific approach for running low-level driver-type software in DOS, while FSFD (File System Filter Driver) refers to a specific type of driver in, for example, Windows NT/Windows 2000/Windows XP (Windows™, Windows NT™ and Windows XP™ are all Registered Trademarks of Microsoft Corporation). Both of these are specific techniques for certain operating systems, but they accomplish the same type of monitoring. In this type of monitoring, the piece of software is installed globally such that it hooks all file accesses in the system, rather than all file accesses from a given program.

The LD_LIBRARY_PRELOAD refers to a specific technique approach (on Unix-type operating systems) for “hooking” all file access from a given program. To understand how this operates, it is necessary to first understand how programs load. Most programs are so-called ‘dynamically linked’, that is to say they depend on files other than themselves and the operating system. Specifically, so called ‘dynamic libraries’ or ‘shared libraries’ contain sets of routines that the program requires, but which are not tightly bound into the program itself. These libraries can (and usually are) used by many programs in the system. For example, calls such as Open and Close (related to file accesses) are typically used by programs from shared libraries. This approach is often preferred, as code that is not specifically related to the function of the program is held elsewhere, can be fixed and upgraded independently of the program, and can be shared by many programs.

When a program is executed, the so-called “loader” (a piece of system software that manages the loading of programs) performs tasks to assist the loading of the program. Amongst other things, the “loader” determines which libraries the program requires, loads them, and makes them available to the program (such that the program itself does not have to be aware that some of the calls it is doing are into shared libraries and some are not.)

Many versions of Unix (for example) permit the behavior of the loader to be overridden, in such a way as to load one library before all the others (and to load libraries that would otherwise not have been loaded). This is typically accomplished by setting an environment variable called LD_LIBRARY_PRELOAD to the name of the library to load. This technique can be used to load a library that provides the standard file access functions (open, close, read, write, seek, etc). This library then receives control when the program attempts to use those file access functions, and the library then does whatever checking (in the case of anti-virus software) or bookkeeping (in the case of this invention) it has to do, and then relays the call through to the actual, standard implementation.

Based on the foregoing several paragraphs of discussion, those skilled in the art should appreciate that various approaches to performing the required monitoring can be used, and should further appreciate that this invention is not limited to using only TSD/FSFD or LD_LIBRARY_PRELOAD-type file system monitoring techniques.

The foregoing description has provided by way of exemplary and non-limiting examples a full and informative description of the best method and apparatus presently contemplated by the inventors for carrying out the invention. However, various modifications and adaptations may become apparent to those skilled in the relevant arts in view of the foregoing description, when read in conjunction with the accompanying drawings and the appended claims. As but some examples, the use of other similar or equivalent data structures and data transformation tools may be attempted by those skilled in the art. In addition, certain operations described above may be performed via or over a data communications network. However, all such and similar modifications of the teachings of this invention will still fall within the scope of this invention.

Furthermore, some of the features of the present invention could be used to advantage without the corresponding use of other features. As such, the foregoing description should be considered as merely illustrative of the principles of the present invention, and not in limitation thereof.

1. A computer program stored on a computer-readable medium and containing computer program instructions that direct a computer to monitor the operation of at least one data transformation tool and to automatically record information, from data set manipulation behavior of the at least one data transformation tool, that is descriptive of dependencies inherent in data sets being manipulated.

2. A computer program as in claim 1, where said recorded information is used during subsequent operation of said at least one data transformation tool so as to avoid manipulating a particular data set that the recorded information indicates, in conjunction with other information, would not have changed since it was created or last modified.

3. A computer program as in claim 2, where said other information comprises at least data and time information that reflects when the data set was created or last modified.

4. A computer program as in claim 1, where said data transformation tool comprises a software project building tool, where the data sets being manipulated comprise files, and where the computer program instructions that direct the computer to monitor the manipulation behavior monitor a file system.

5. A computer program as in claim 4, where the computer program instructions that direct the computer to monitor the manipulation behavior monitor and record at least the reading from files, the modification of files and the creation of files.

6. A computer program as in claim 4, where the software project building tool comprises a plurality of sub-tools, where the computer program instructions that direct the computer to monitor the manipulation behavior monitor a file system during operation of each sub-tool and record the information in a dependency table data structure based on at least the activity of the sub-tool in reading from files, modifying files and creating files.

7. A computer program as in claim 6, where there is a dependency table data structure created during operation of each of said sub-tools, and further comprising a combined dependency table data structure that is derived from a plurality of the dependency table data structures.

8. A computer program as in claim 7, where said combined dependency table data structure comprises, for each sub-tool, a record that comprises at least an identification of the data objects read, external data objects read, and data objects created.

9. A computer program as in claim 4, where the project building tool uses the recorded dependency information in order to determine whether individual ones of a plurality of build steps need to be executed based on at least times associated with various input and output files identified by the dependency information.

10. A method to operate a computer, comprising:
monitoring the operation of at least one data transformation tool; and
automatically recording information, from data set manipulation behavior of the at least one data transformation tool, that is descriptive of dependencies inherent in data sets being manipulated.

11. A method as in claim 10, where said recorded information is used during subsequent operation of said at least one data transformation tool so as to avoid manipulating a particular data set that the recorded information indicates, in conjunction with other information, would not have changed since it was created or last modified.

12. A method as in claim 11, where said other information comprises at least data and time information that reflects when the data set was created or last modified.

13. A method as in claim 10, where the data transformation tool comprises a software project building tool, where the data sets being manipulated comprise files, and where monitoring monitors a file system.

14. A method as in claim 13, where monitoring the file system monitors and records at least the reading from files, the modification of files and the creation of files.

15. A method as in claim 13, where the software project building tool comprises a plurality of sub-tools, and where monitoring the manipulation behavior comprises:
monitoring a file system during operation of each sub-tool; and
recording information in a dependency table data structure based on at least the activity of the sub-tool in reading from files, modifying files and creating files.

16. A method as in claim 15, where there is a dependency table data structure created during operation of each of said sub-tools, and further comprising creating a combined dependency table data structure from a plurality of the dependency table data structures.

17. A method as in claim 16, where said combined dependency table data structure comprises, for each sub-tool, a record that comprises at least an identification of the data objects read, external data objects read, and data objects created.

18. A method as in claim 13, where the project building tool uses the recorded dependency information in order to determine whether individual ones of a plurality of build steps need to be executed based on at least times associated with various input and output files identified by the dependency information.

19. A computer system, comprising:
a processor for executing software that implements a data transformation tool; and
a monitor to monitor the operation of the data transformation tool and to record information obtained from observing data set manipulation behavior of said data transformation tool, the recorded information being descriptive of dependencies inherent in the data sets being manipulated.

20. A computer system as in claim 19, where said recorded information is used during subsequent operation of said data transformation tool so as to avoid manipulating a particular data set that the recorded information indicates, in conjunction with other information, would not have changed since it was created or last modified.

21. A computer system as in claim 20, where said other information comprises at least data and time information that reflects when the data set was created or last modified.

22. A computer system as in claim 19, where the data transformation tool comprises a software project building tool, where the data sets being manipulated comprise files, and where said monitor monitors a file system.

23. A computer system as in claim 22, where said monitor monitors and records at least the reading from files, the modification of files and the creation of files.

24. A computer system as in claim 22, where the software project building tool comprises a plurality of sub-tools, and where said monitor monitors said file system during operation of each sub-tool and records information in a dependency table data structure based on at least the activity of the sub-tool in reading from files, modifying files and creating files.

25. A computer system as in claim 24, where there is a dependency table data structure created during operation of each of said sub-tools, and a combined dependency table data structure that is created from a plurality of the dependency table data structures.

26. A computer system as in claim 25, where said combined dependency table data structure comprises, for each sub-tool, a record that comprises at least an identification of the data objects read, external data objects read, and data objects created.

27. A computer system as in claim 22, where the project building tool uses the recorded dependency information in order to determine whether individual ones of a plurality of build steps need to be executed based on at least times associated with various input and output files identified by the dependency information.

28. A computer system, comprising:
a processor for executing software that implements a software project building tool comprised of a plurality of sub-tools used for implementing a plurality of build steps;
a memory that stores a file system containing files; and
coupled to said processor and to said file system, a monitor to observe the operation of the software project building tool, said monitor creating a dependency table data structure that is descriptive of at least input and output file dependencies inherent in the operation of said plurality of sub-tools, said software project building tool being responsive to said dependency table data structure to determine whether individual ones of the plurality of build steps are required to be executed based on at least times associated with files identified by said dependency table data structure.

29. A computer system as in claim 28, where said dependency table data structure comprises, for each sub-tool, a record that comprises at least an identification of data objects read, external data objects read, and data objects created.

30. A computer system as in claim 28, where said monitor observes file activity for files representing inputs, intermediate outputs, and outputs of the software project building tool.

31. A computer system as in claim 28, where said monitor is operated each time said software project building tool is operated for updating the dependency information.

32. A computer system as in claim 28, where said dependency information is generated on the flyby said monitor each time said software project building tool is operated.

33. A computer system as in claim 28, where said monitor uses TSD/FSFD file system monitoring.

34. A computer system as in claim 28, where said monitor uses LD_LIBRARY_PRELOAD file system monitoring.

35. A computer system as in claim 28, where said system is coupled to a data communications network for enabling communication with a user related to operation of at least one of said monitor and software project building tool.

36. A computer system as in claim 28, where said system is coupled to a data communications network for enabling communication with a user so as to provide the user at least with information that is indicative of a content of the dependency table data structure.
